(19) United States
(12) Patent Application Publication
(10) Pub. No.: US 2010/0192453 A1
(43) Pub. Date: Aug. 5, 2010

(54) Production of biodiesel

(75) Inventor: Naresh Pachauri, Arcadia, CA (US)

Correspondence Address: WILLIAM W. HAEFLIGER, 201 S. LAKE AVE, SUITE 512, PASADENA, CA, 91101, US

(73) Assignee: VERT CAPITAL LLC, dba VERT BIODIESEL

(21) Appl. No.: 12/322,316

(22) Filed: Feb. 2, 2009

(51) Int. Cl. C10L 1/02; B01J 19/00

(52) U.S. Cl. 44/307; 422/129; 44/445

(57) ABSTRACT

A continuous flow, RD reactor system, that comprises, in combination a reaction column, first means feeding vegetable oil, liquid methanol and catalyst to the upper interior of the column, a condenser reclining methanol vapor for the upper interior of the column, and for producing condensed methanol recycled to the column upper interior, and for delivering a stream of refluxed methanol liquid to the upper interior of the column, and several means for receiving product biodiesel and liquid methanol for the lower interior of the column, and for separating Biodiesel in a primary product stream and returning methanol vapor to the column.

### BACKGROUND OF THE INVENTION

This invention relates generally to the production of biodiesel, and more particularly to highly effective apparatus and methods of such production.

Biodiesel is a renewable fuel for diesel engines. Biodiesel consists of long chain fatty acid alkyl esters and is made from vegetable oils, recycled cooking oils, or animal fats. The process of making biodiesel is referred to as transesterification, and it starts with the addition of vegetable oil, catalyst, and methanol into a reactor. The products of transesterification are biodiesel and crude glycerol containing impurities such as catalyst, methanol, and soap. Biodiesel and glycerol are immiscible and separable by gravity differences. After separation, biodiesel is washed and stored while the crude glycerol is refined or value added to make other useful products.
There are many benefits in using biodiesel compared to petroleum diesel, including
Less dependency on foreign oil
Revenue increase for U.S. farmers and agriculture
Improvement of air quality and environment, and
Positive energy balance for biodiesel (Janulis, 2004).

The process of making biodiesel is called transesterification which composes of a set of equilibrium reactions in series (Noureddini et al., 1997). Tri-glycerides (TG) are first converted to di-glycerides (DG). The di-glycerides are then converted to mono-glycerides (MG). Lastly, the mono-glycerides are reduced to fatty acid esters and glycerol (GL). Overall, 1 mole of tri-glyceride (vegetable oil or animal fat) reacts with 3 moles of alcohol to produce 3 moles of alkyl esters (biodiesel) and 1 mole of glycerol, a by-product.

In practice, 100% excess methanol is used for the transesterification, which is recovered later via distillation. In general, a basic or an acidic catalyst is used in transesterification Formation of Soap: The free fatty acids (FFA) in the oil react with the basic catalyst and lead to the formation of soap (FIG. 1.2). The higher the free fatty acids content, higher are the soaps. Soap formation is a much faster reaction that transesterification.

The percentage extents of the free fatty acids decide the type of the process to be selected for biodiesel production. Most vegetable oils (soybean, canola, palm, mustard and rapeseed) contain low percentage of free fatty acids (<1%).

Crude vegetable oils can be refined and degummed to get rid of free fatty acids and phospholipids respectively. In refining, the caustic is reacted with the feedstock oil to convert FFA's to soap which are then separated out using a centrifuge. Degumming involves the hydrolysis of the feedstock oil with water to remove the gums.

Animal tallow and yellow grease have higher levels of free fatty acids (up to 15%). Yellow greases are the mixtures of vegetable and animal fats. Trap greases contain between 50 and 100$ free fatty acids (Van Gerpen et al., 2005).

Alcohol: The stoichiometric amount of the alcohol needed for the transesterification reaction is 3 moles for every mole of oil reacted (molar ratio of 3:1). In biodiesel production processes, this ratio is typically kept at 6:1 (Marchetti et al., 2007). The excess alcohol pushes the reaction of oil conversion to fatty esters. The unreacted alcohol is recovered afterwards and recycled back into the process for reuse.

Methanol is the most commonly used primary alcohol for biodiesel production. Other alcohols are ethanol, iso-propanol, and butanol. High water content in the alcohol (or in the transesterification reaction) results in poor yields and high levels of soap in the final product. Unlike ethanol, methanol does not form an azeotrope with water, enabling an easier recovery as compared to ethanol.

Catalyst: Typical catalyst used in transesterification are acidic or basic in nature.

Basic Catalysts: If the feedstock contains less than 5% wt FFA, basic catalysts are used for biodiesel production. The basic catalysts include sodium hydroxide (NaOH), potassium hydroxide (KOH), potassium methoxide (KOCH₃) and sodium methoxide (NaOCH₃). The basic catalysts also neutralize the FFA in the oil to form soaps with land up in glycerol layer of the product. The basic catalysts are hygroscopic. A significant amount of water in catalyst can create problems in transesterification. Sodium mothoxide in methanol is preferred over NaOH dissolving in methol because of the water formation in the latter.

Acidic Catalysts: When feedstock contains higher FFA content, typically higher than 5% wt, acid catalysts are used to convert the FFA and triglycerides into fatty acid esters (Canakci and Van Gerpen, 2003). The commonly used acid catalysts are sulfuric acid and phosphoric acid. The kinetics of acid catalyst is slower than the basic catalysts and demand high alcohol to TG ratio (typically 20:1). Another drawback using acidic catalyst is the formation of the water in process, as shown in FIG. 1.4.

There is need for improvements in system, apparatus and methods for producing biodiesel; and in particular there is need for improvements in biodiesel production employing reaction distillation (RD), which allows transesterification and recovery of withdrawal in a single system employing a RD column receiving feedstock from an in-line static mixer, effectively substandard reduction of excess alcohol in the feed, shorter reaction time and enhanced recoveries.

Also, employment of reaction distillation in a single unit for reaction and recovery, facilitate lower capital costs. Also, in reactive distillation (RD), both chemical conversion and distillative separation of the product mixture are carried out simultaneously in one unit. By combining the separation process within the reactor, products can be removed from the reaction zone continuously which significantly improves the selectivity, conversion, and overall yield. In RD, heat of reaction can be directly utilized for the reaction.

Employment of RD reduces the equipment and operational costs. Since the product is exposed to heat only once, chances are less for productive degradation. Combination of distillation and reaction in RD helps the overall process to occur in shorter time and to help generate less product streams.

### SUMMARY OF THE INVENTION

It is a major objects of the invention to provide improved means and method to achieve the benefits and problems, as referenced to. Basically, the system of the invention includes:
a) a reaction column,
b) first means feeding vegetable oil, liquid methanol and catalyst to the upper interior of the column,
c) a condenser reclining methanol vapor for the upper interior of the column, and for producing condensed methanol recycled to the column upper interior, and for delivering a stream of refluxed methanol liquid to the upper interior of the column,
d) and several means for receiving product biodiesel and liquid methanol for the lower interior of the column, and for separating Biodiesel in a primary product stream and returning methanol vapor to the column.

Another object includes provision of receptical the system of Claim 1 including receptical plates within the column to receive said feed oil, methanol and catalyst for mixing and separating methanol vapor from oil and catalyst draining through the plates.

Yet another object includes second means employed of a re-boiler recovery. The systems of claim 1 wherein said second means includes a re-boiler receiving said biodiesel and methanol liquid for the lower interior of the column and operating to produce methanol vapor returned to the column, and biodiesel in said product stream. A condenser is typically employed for receiving biodiesel from the re-boiler for cooling the product stream.

Yet another object is to provide optimum temperature condition within the column, and in the mixed oil and methanol feedstock supplied to the column, as will be seen.

These and other objects and advantages of the invention, as well as the details of an illustrative embodiment, will be more fully understood from the following specification and drawings, in which:

### DRAWING DESCRIPTION

FIG. 1.1 lists transesterification reaction;

FIG. 1.2 shows a soap formation reaction;

Table 1.1 is a fatty acid profile of vegetable oils;

Table 1.2 is a fatty acid profile of animal fats;

FIG. 1.3 is a catalyst preparation reaction;

FIG. 1.4 is an esterification reaction;

FIG. 1.5 is a diagram showing a principle of distillation, as in a RD column;

Table 2.1 is a glycosides profile;

FIG. 2.1 is an experimental showing of a re-boiler zone;

Table 2.2 shows experimental results;

FIG. 2.2 is a graph of variables as shown, at two temperatures;

FIG. 2.3 is a graph showing effect of temperatures;

Table 2.3 is an analysis table;

Table 2.4 is a design table;

Table 3.1 is a fatty acid profile of feedstock canola oil;

Table 3.2 shows acid and water content of feedstock;

FIG. 3.1 is a section showing helical rotary mixing elements in a static mixer;

FIG. 3.2 is a detailed schematic view of a re-boiled structure or zone;

Table 3.3 is a listing of sieve plates in an RD column, with physical parameters;

FIG. 3.3 is system diagram;

FIG. 3.4 is a diagram of mixing occurring on mixing plates in an RD column;

Table 3.4 is a modes results table;

FIG. 3.5 is a comparison graph;

Table 3.5-3.9 are analysis tables;

FIG. 3.6 is a glycerides profile in an RD column, vs residence time;

FIGS. 3.7 and 3.8 are reaction diagrams;

Table 3.10 lists experimental results;

FIGS. 3.9 and 4.0 (not used);

Table 4.1 is a result comparison listing;

FIG. 4.1 is a diagram of a re-boiled integrated with an RD column and showing glycerol accumulation;

FIG. 4.2 to 6 (not used)

FIG. 6a is a diagram of a re-boiler in direct operation communicating with the lower interior of an RD column; and

FIG. 6b is like FIG. 6a, but showing modifications.

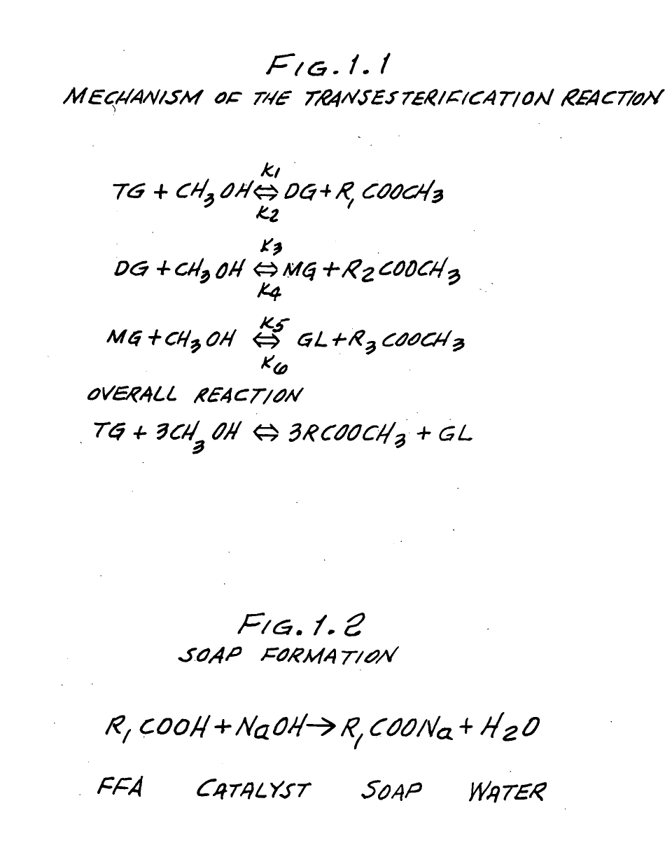

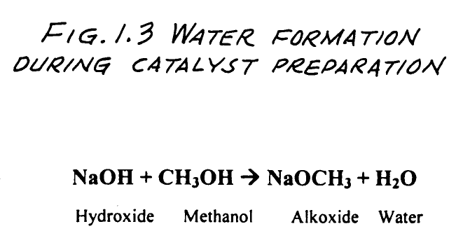

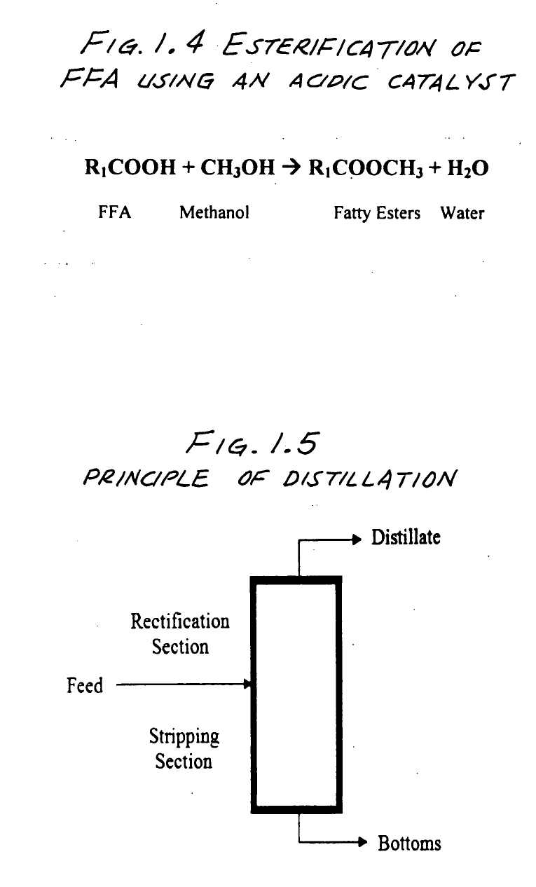

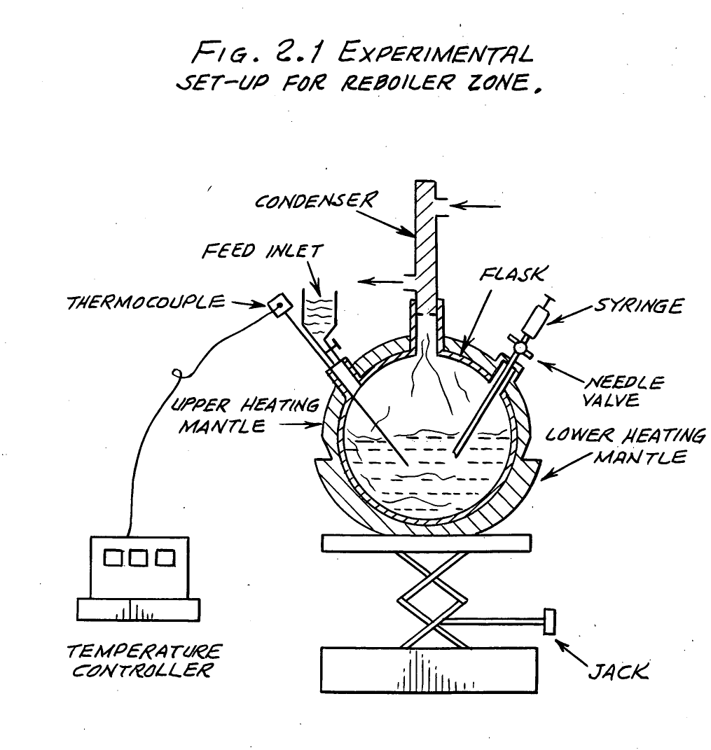

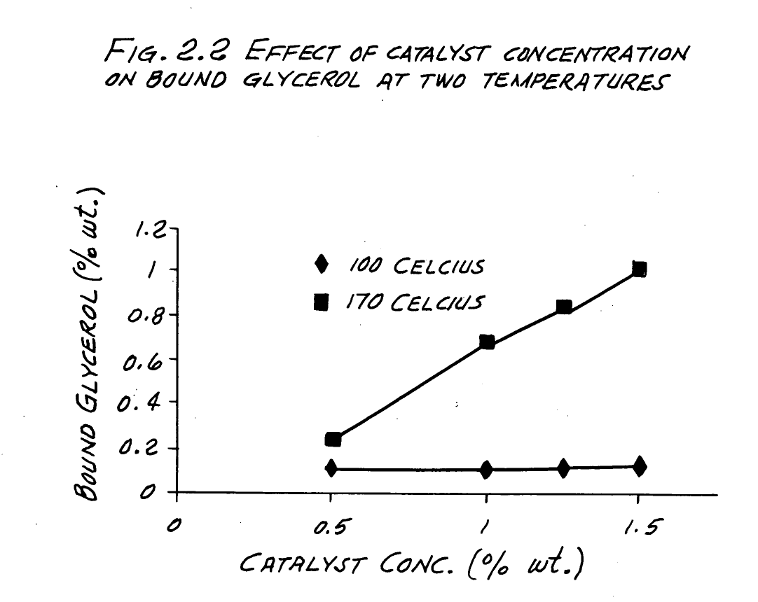

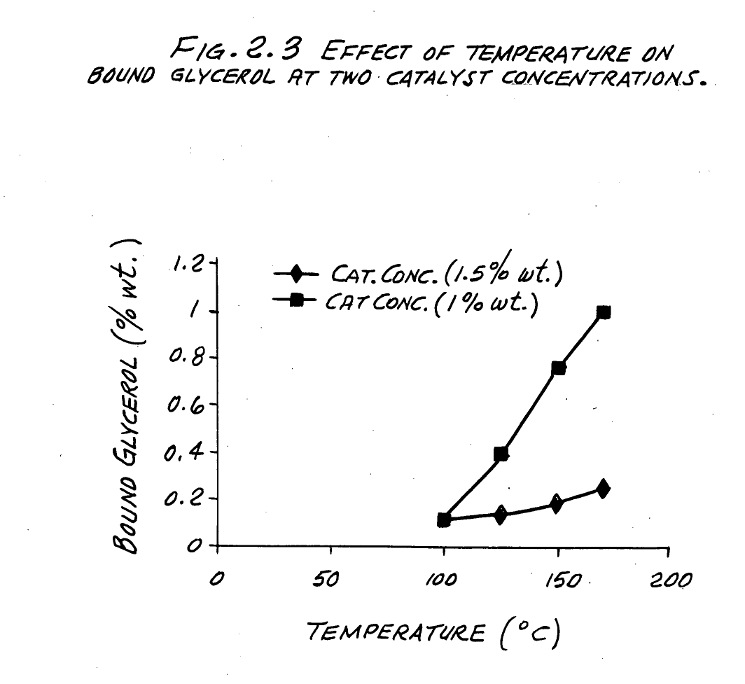

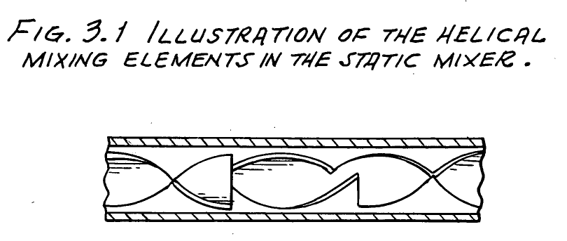

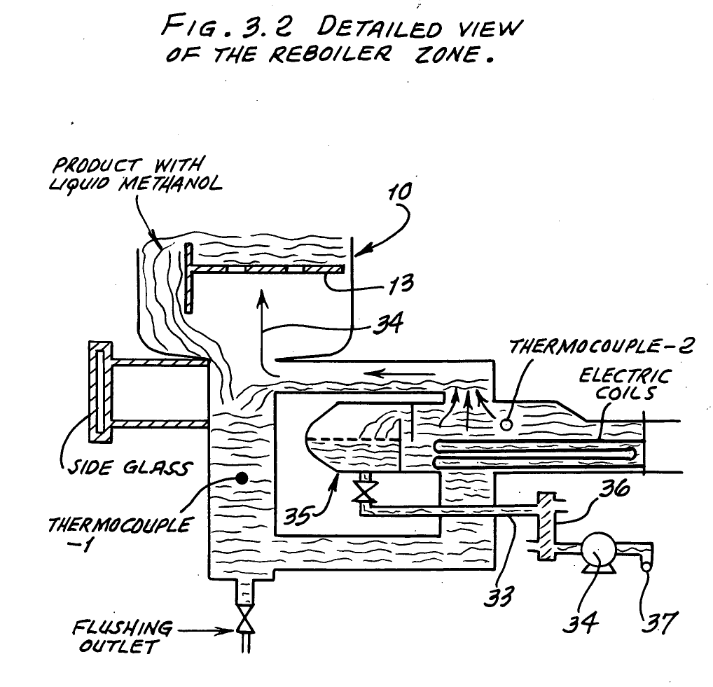

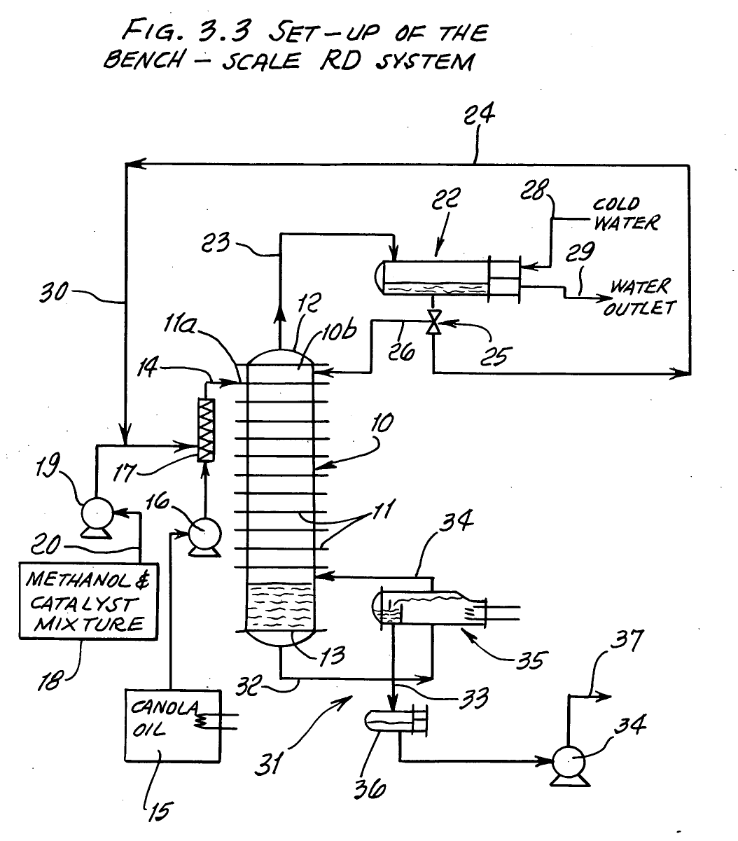

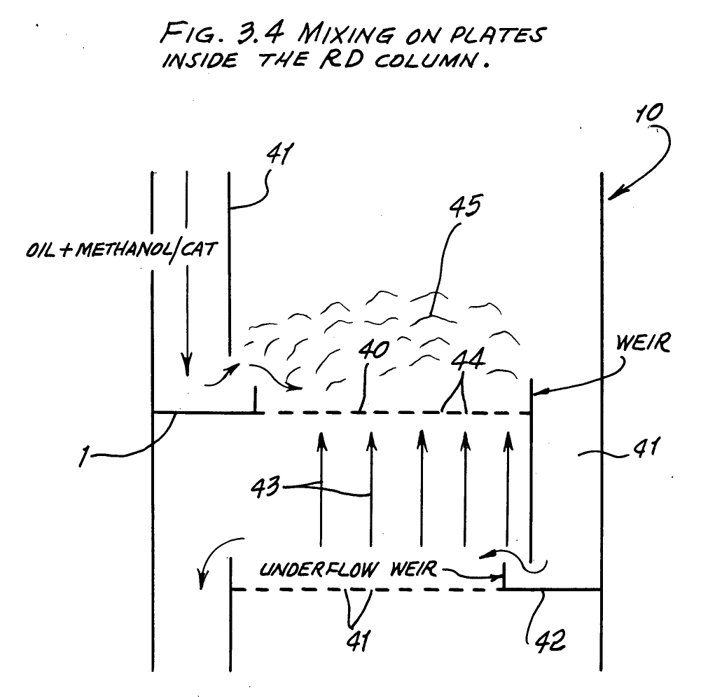

### DETAILED DESCRIPTIONS

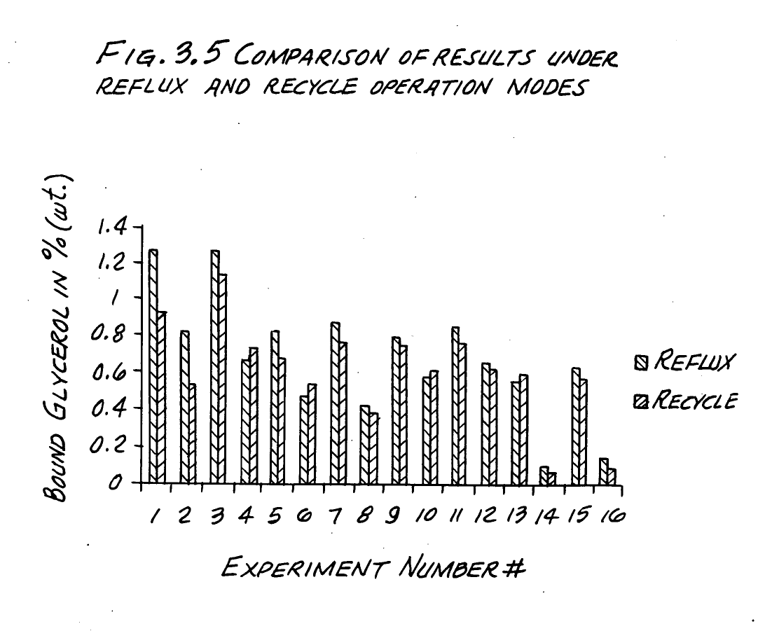

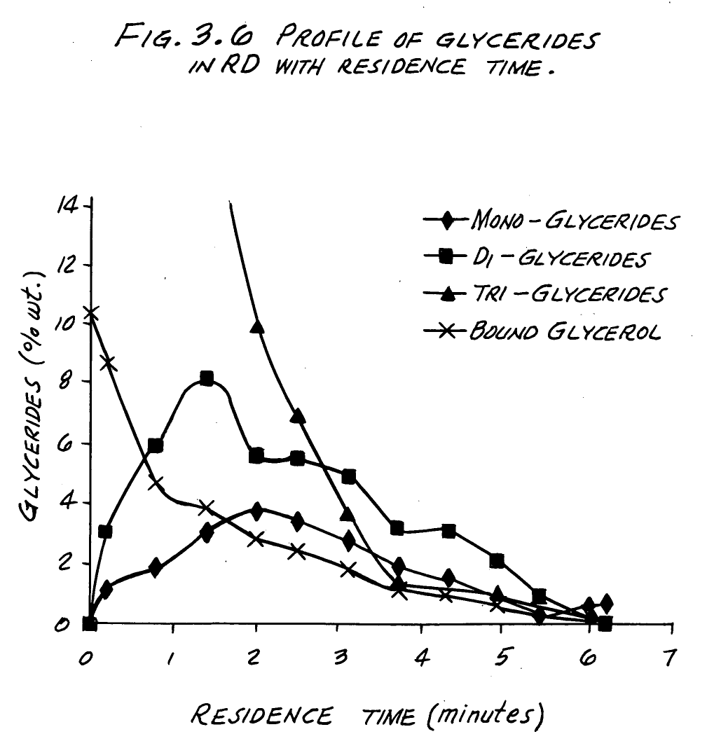

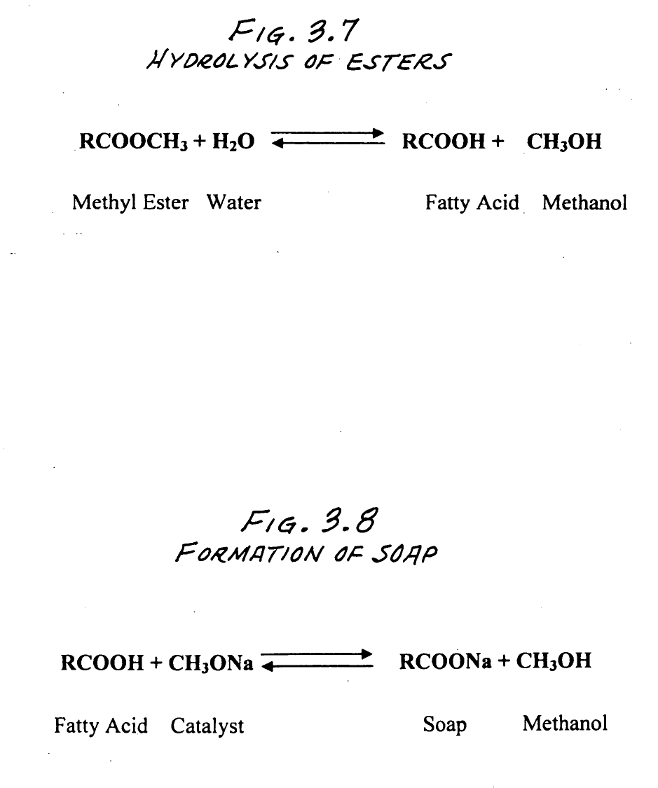

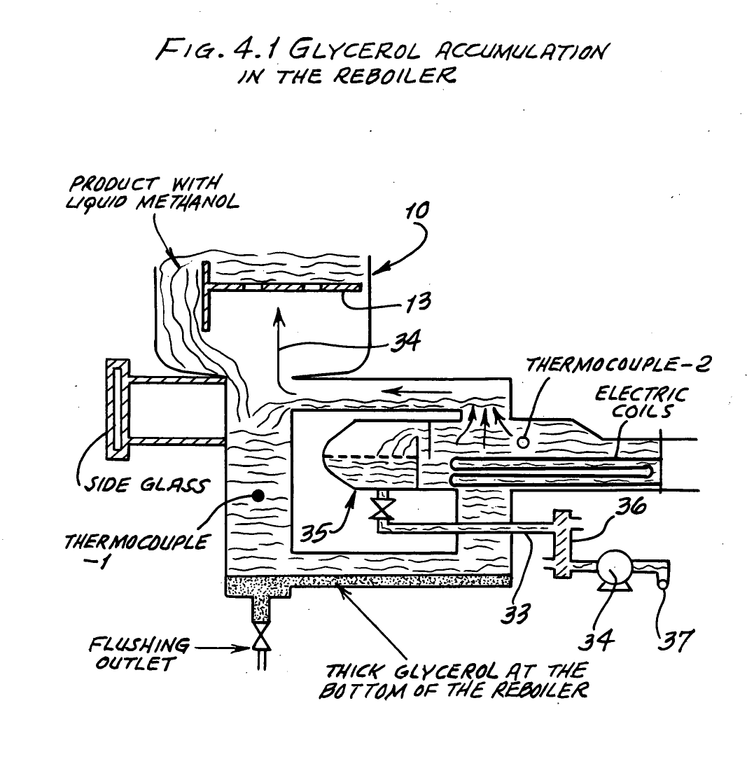

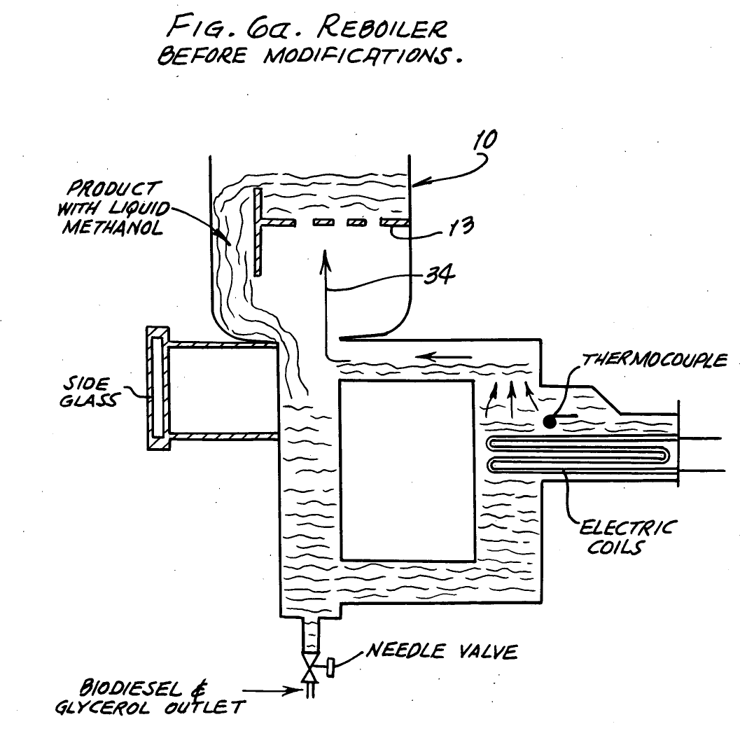

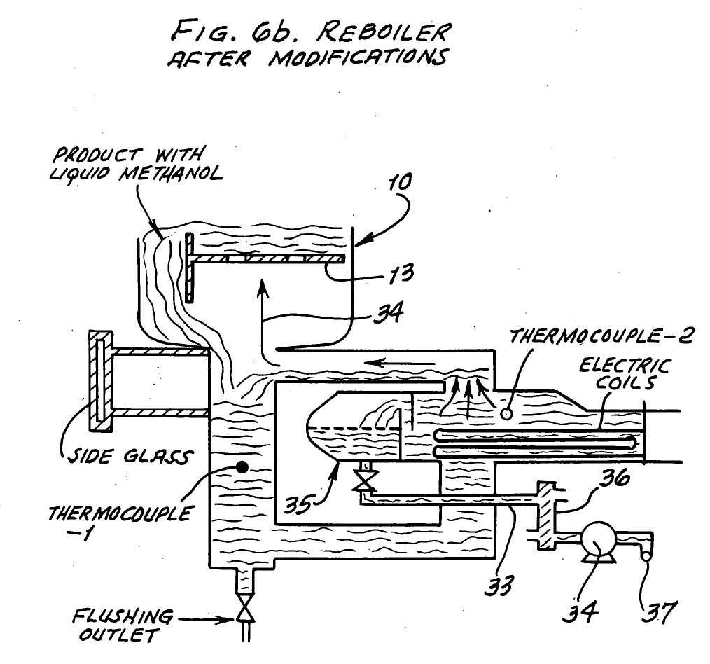

In FIG. 3.3, showing an RD (reactive distillation) system, a reaction column 10 has a vertical section of plates 11 including a feed plate 11a near the top 12 of the column, and a bottom plate 13. A liquid feed is introduced at 14, consists of a mixture of vegetable oil (for example canola oil) methanol and catalysts. Canola oil is fed from a source 15, via pump 16, for the mixer 17; and a mixture of methanol and catalyst is fed from source 18, via a pump 19 to the mixer 17. Recycled methanol is also fed at 20 to the mixer 17. Accordingly, a first means is provided for feeding vegetable oil, liquid methanol and catalyst to the column upper interior.

Also provided in a condensed 22 receiving methanol vapor for the upper interior lob of the column, as in path 23. The condenser is operated to produce condensed methanol at 23, which is recycled in path 24 and reflux valve 25 for delivery of methanol liquid to the column upper interior, at 26. Liquid coolant such as water is passed to the condenser at 28 withdrawn at 29. Valve 25 is operated to control return flow of recycled methanol, at 30, to mixer 17.

A second means is also provided, as at 31, for receiving liquid product biodiesel (produced in the column 10), and for pathway 32 from the column lower interior, and for separating product biodiesel in a stream at 33, with separated methanol vapor returned at 34 to the column. Such second means typically includes a re-boiler shown at 35.

Typical operating conditions include maintenance of temperature within the column between 60° C. and 65° C.; maintenance of temperature (pre-heating) of the feed oil and methanol at the entrance to the column at between 57° C. and 60° C., ie just below the temperature within the column; and maintenance of the ratio of methanol and oil in the feed at about 3/1 (molar), for pushing transesterification to near completion. A condenser 36 is typically provided to receive the product stream 33, for cooling same; and a pump 34 delivers the product stream of biodiesel and glycerol at 35.

### EXAMPLE

The column was rinsed with methanol to take out any traces of water and impurities before experimental runs were started. Initially, for any condition of Table 3.4, 475 ml of oil with corresponding amounts of catalyst and methanol was pumped into the reboiler zone. All inlet and outlet valves were closed during this period. The mixture was heated to 120-130° C. in the reboiler. Methanol vapor rising from the reboiler started to warm up the entire column. Methanol vapor was then condensed at the top and totally refluxed back to the system. When the temperature profile of the column remained constant for 20 minutes, it was assumed that steady state had reached. Higher set point temperatures (150-160° C.) led to faster establishment of steady states. However product stability was an issue at higher temperatures. Representative time to achieve steady state was 40-50 minutes for a set point temperature of 120-130° C. in the reboiler. The typical temperature profile of the RD column at a steady state is shown in Table 3.9. In general, the temperature stayed constant at 60° C. for the first 15 plates while it fluctuated between 63 and 65° C. for the last five plates.

The temperature at Plate 1 defined the temperature of feed to be introduced into the RD column. Generally, this temperature was in the range of 57-60° C. Once the steady state was achieved, the feed oil and catalyst-methanol solution were ready to be pumped in. The feed oil was preheated to 55-57° C. (maintained closer to the temperature of feed mixer). The mixture of oil and methanol-catalyst solution was pumped through the feed mixer where 30% to 60% conversion took place. (He et al., 2007).

The mixture then entered the RD column at feed Plate 1, flowed across the plate 40, and then downward through the downcomer 41 to the next plate 42 (FIG. 3.4). While flowing across the plate, the liquid was held on top of each plate by the upward-flowing methanol vapor rising through the perforated plate holes as at 44. The upward flowing methanol vapor 45 bubbles through the liquid phase and creates an agitating effect, on the flow on each plate. Each plate can be considered as a mini reactor, contributing to the operation of the overall RD reactor. Once the product mixture reaches the reboiler zone, natural circulation occurs due to the density difference between the reboiler inlet (liquid methanol with biodiesel and glycerol) and the reboiler outlet of mainly biodiesel and glycerol (FIG. 3.2). The excess methanol was vaporized off and delivered at 34 to ride upwards through the column.

The condensed methanol vapor could either be refluxed back to column or recycled. Recycling involved diverting the condensed methanol to its storage or introducing it just before the feed mixer. Since a rectification section was not provided in the RD column, recycling was often associated with entrainment in the column because of high methanol vapor velocities near the feed tray. Therefore condensed methanol may have oil and catalyst in it and could not be mixed with pure methanol in reservoir. This leads to choice of reflux as an operation parameter over recycling.

Higher methanol:oil ratio was the key to drive the transesterification toward completion. Methanol poured into the reboiler during the start-up served as the excess alcohol. Continuous boiling of the excess methanol from the bottom (reboiler) and condensing it at the top (condenser) created a rich environment of high methanol:oil ratio in the column that pushed the transesterification to near completion. Higher temperatures in the reboiler ensured the minimal methanol loss in the product mixture, which in turn allowed to keep the methanol:oil ratio in the feed closer to the stoichiometric value of 3:1 (molar). As a result, the use of excess alcohol in the feed was considerably reduced. Product was continuously withdrawn from the reboiler through a metering pump and immediately cooled down in a condenser before discharge. The product was collected in a decanter and the glycerol was separated from the methyl esters by gravity.

Samples were taken from ports located throughout the column. Each sample (3 mL) was washed with 3 mL of deionized water in a vial immediately and shaken well to stop the reaction. Washing helped removing the majority of free glycerol. It was then centrifuged at 3000 rpm for 20 minutes and working samples were drawn from the top layer of the treated sample. Bound glycerol was determined by GC following the ASTM Standard D6584 (ASTM, 2000). Soap measurements were conducted according to AOCS Cc 17-79 (AOCS, 1996). Water contents (moisture content or MC) were measured with an automatic Karl-Fisher Coulometer. Acid value was measured according to the ASTM Standard D974 (ASTM, 2000).

Major process variables studied in the study included: (1) methanol:oil molar ratio, (2) reaction time, (3) catalyst concentration, (4) reboiler temperature, and (5) methanol circulation mode (recycle or reflux). The parameters for evaluating the system performance included the bound glycerol (BG) and soap formation in the product steam. Experimental results were analyzed using the statistical package DOE Pro XL (Digital Computations, Inc., Colorado Springs, Colo.). Effects of various process variables on the evaluating parameters were determined from the results of the statistical analyses.

To evaluate the effect of process parameters, a full-factorial experimental design was employed (Table 3.4). The trials were randomly conducted regardless of the experimental number. Data points of experimental results were averaged from triplicate samples. The process parameters were analyzed using the statistical package DOE PRO XL. Averages and standard deviations of the bound glycerol data obtained from reflux and recycle operation modes are summarized in rightmost columns of Table 3.4.

FIG. 3.5 is the graphical presentation of data in Table 3.4 to show the bound glycerol trends under reflux and recycles operation modes. Recycle mode produced slightly better results. This could be explained on the basis of higher methanol:oil molar ratio present in recycling (to the feed mixer). At higher values of methanol:oil ratio, catalyst application and residence time (Experiments #14 and #16), the content of bound glycerol was the lowest and meet the ASTM specifications. The worst result was observed in Experiments #1 and #3, which correspond to the lowest values of catalyst application, methanol:oil ratio and residence time. ANOVA analysis on process variables and their possible two-way and three-way interactions showed that residence time had the maximum contribution followed by methanol:oil ratio and catalyst concentration.

Almost zero probability values for variables A, B and D indicated that they were significant in contributing to the lowering the bound glycerol. The variable C (temperature) was not statistically significant in the explored ranges. None of the two-way and three-way interactions were significant. Observations and analysis concluded that variables of residence time, methanol:oil ratio and catalyst concentration (variables A, B, and D respectively) had a significant effect on reducing the bound glycerol. These results were important information for use in designing the second set of experiments.

Frequent entrainment problem in recycling mode showed its disadvantage and suggested to choose reflux as the operation mode in Stage 2 experiments. Since reboiler temperature (Variable C) did not play a crucial role in overall system performance, a fixed temperature of 130° C. was employed. Due to the limitation of the reboiler heating duty, a methanol:oil ratio higher than 15:1 could not be explored. Residence time could be increased by slowing down the feeding rate but it would decrease the productivity of the reactor. Higher catalyst concentration would increase operating cost and soap formation, therefore, effects of lower catalyst concentrations were studied with the fixed variables B and D (residence time of 7 minutes, initial molar methanol: oil ratio of 15:1, respectively) the results of triplicate are summarized in Table 3.6 and the input and output flow rates are listed in Table 3.7.

As shown in Table 3.6, result from Experiment 19 met the bound glycerol specifications (<0.24% wt). The RD system was planned to be tested on this condition for 72 hours continuously. In the testing, samples were taken from the reboiler in 4 hours interval and analyzed for bound glycerol, soap and water content for the 72 hours. Experimental results are summarized in Table 3.8. Acid value was found to be zero for all set of experiments, therefore, not listed.

In the first 8 hours the bound glycerol was well within the 0.24% wt. However, product quality started deteriorating after 12 hours. This could be due to gradual methanol loss over the time through the product output. Although higher temperature prevented the most of methanol from loss in the product, small quantity of methanol contained in the mixture was still drawn out from the product stream. This could limit the desired methanol:oil ratio in the column necessary for conversion. With an assumption that no excess methanol is left in the column after 8 hours for desired quality conversion, an average feed molar ratio was calculated as 3.3 moles of methanol per mole of oil. The design changes in the reboiler and further hardware modifications (such as addition of liquid level sensors) could rectify this problem. Table 3.8 shows the glycerides profile of the RD system tested for 72 hours. Table 3.9 shows the glycerides, water, and soap profiles of RD system at different positions for Sample 1 collected after 4 hours of operation. FIG. 3.6 is the graphical presentation of the data in Table 3.9.

Presence of water in the RD system is highly undesirable. Water can interfere with the reaction proceeding to completion and hydrolyzes the esters or triglycerides to produce free fatty acids (FIG. 3.7).

The fatty acids formed consume the catalyst and increase the chances of reverse reaction. The reaction product of the basic catalyst and fatty acid is the undesired soap (FIG. 3.8).

Input and output streams of the RD system were continuously monitored for water accumulation (Table 3.8). After 72 hours, the operation was shut down and a sample from the reboiler, which was the overall mixture from the column and the reboiler, was analyzed for final water content. The net amount of water accumulation in the reboiler was found to be 7% wt. Table 3.9 shows the details of water content at different positions in the RD system after 4 hours operation. It is noticed that water accumulated as it goes down along the column and reached 3000 ppm on the last plate. Water level in the reboiler was low (250 ppm) and as the same level as in the feed due to the higher operating temperature of the reboiler. Higher soap values towards the end hours of the operation confirmed the consequence of this situation (Table 3.8).

Final results for RD best biodiesel sample are listed in Table 3.10.

TABLE 3.10
Experimental results as compared to ASTM
specifications

| | | ASTM | |
|---|---|---|---|
| Property | Standards | Limits | Results |
| Bound glycerol (% wt) | ASTM | <0.24 | 0.19 |
| | D6584 | | |
| Total glycerol (% wt) | ASTM | <0.24 | 0.19 |
| | D6584 | | |
| Flash point (° C.) | ASTM D93 | >130 | >150 |
| Kinematic viscosity | ASTM D445 | 1.9-6.0 | 4.0 |
| (40° C.) | | | |
| Acid number (% wt) | ASTM D974 | 0.5 max | 0.0 |

A bench-scale RD system was tested at modified operating conditions to bring down the bound glycerol from 1.2% wt to 0.19% wt with a standard deviation of 0.07 for early 8 hours of operation. For this period, methanol feed molar rate was reduced to 3.3 moles, a ratio close the stoichiometric value of 3 moles. A small amount of methanol in the final product made the separation of biodiesel and glycerol easy. The reaction time for this condition was approximately 7 minutes. Catalyst usage was cut down to from 1.5% wt to 1.1% wt. Longer hours of operation decreased the biodiesel product quality; this was because of the reasons explored during the testing (loss of excess methanol, water and glycerol accumulation). Water accumulation was identified as a major limitation of RD in current set-up. It leads to the hydrolysis of the glycerides/esters and eventually the undesirable soap formation. Further improvements and investigations could make the RD system to be a potential candidate for commercial ASTM grade biodiesel production.

The RD reactor system was endurated comprehensively as the combination of three zones in the system, namely the feed mixer, the column, and the reboiler. The operating conditions of the RD system were optimized to achieve a low level of bound glycerol in the product and higher methanol recovery in the process example. The operating conditions for the RD were: reboiler temperature of 120-130° C., reaction time of approximately 7 minutes, feed methanol to oil molar ratio about 3.3, and a catalyst concentration of 1.1 % wt. Either mode of operation (methanol reflux and recycle) at these conditions was successful in maintaining the level of bound glycerol close to 0.24% wt, the ASTM standard. Methanol reflux was used as the mode of operation for a 72-hours testing of the bench-scale RD system. The final biodiesel product had a bound glycerol content of 0.19% wt with a standard deviation of 0.07. This was significantly reduced from previous efforts that resulted in a bound glycerol of 1.18% wt in the final product. The methanol recovery rate was also increased from 66% to 93%, which was another major advantage of the RD reactor for continuous biodiesel production.

TABLE 1.1
Fatty acid profile of vegetable oils (Marchetti et al., 2007).

| | Fatty acid composition % by weight | | | | | | | | | Acid | Phos | Peroxide |
|---|---|---|---|---|---|---|---|---|---|---|---|---|
| Vegetable oil | 16:1 | 18:0 | 20:0 | 22:0 | 24:0 | 18:1 | 22:1 | 18:2 | 18:3 | value | (ppm) | value |
| Corn | 11.67 | 1.85 | 0.24 | 0.00 | 0.00 | 25.16 | 0.00 | 60.60 | 0.48 | 0.11 | 7 | 18.4 |
| Cottonseed | 28.33 | 0.89 | 0.00 | 0.00 | 0.00 | 13.27 | 0.00 | 57.51 | 0.00 | 0.07 | 8 | 64.8 |
| Crambe | 20.7 | 0.70 | 2.09 | 0.80 | 1.12 | 18.86 | 58.51 | 9.00 | 6.85 | 0.36 | 12 | 26.5 |
| Peanut | 11.38 | 2.39 | 1.32 | 2.52 | 1.23 | 48.28 | 0.00 | 31.95 | 0.93 | 0.20 | 9 | 82.7 |
| Rapeseed | 3.49 | 0.85 | 0.00 | 0.00 | 0.00 | 64.4 | 0.00 | 22.30 | 8.23 | 1.14 | 18 | 30.2 |
| Soybean | 11.75 | 3.15 | 0.00 | 0.00 | 0.00 | 23.26 | 0.00 | 55.53 | 6.31 | 0.20 | 32 | 44.5 |
| Sunflower | 6.08 | 3.26 | 0.00 | 0.00 | 0.00 | 16.93 | 0.00 | 73.73 | 0.00 | 0.15 | 15 | 10.7 |

TABLE 1.2
Fatty acid profile or animal fats (Marchetti et al., 2007).

| Fatty Acid | Lard | Tallow |
|---|---|---|
| Lauric (C12:0) | 0.1 | 0.1 |
| Myristic (C14:0) | 1.4 | 2.8 |
| Palmitic (C16:0) | 23.6 | 23.3 |
| Stearic (C18:0) | 14.2 | 19.4 |
| Oleic (C18:1) | 44.2 | 42.4 |
| Linoleic (C18:2) | 10.7 | 2.9 |
| Linolenic (C18:3) | 0.4 | 0.9 |

TABLE 2.1
Glycerides profile for soy methyl ester.

| | Concentration (% wt) | | |
|---|---|---|---|
| Glycerides | Test 1 | Test 2 | Average |
| Mono-glycerides | 0.0264 | 0.0256 | 0.0260 |
| Di-glycerides | 0.056 | 0.056 | 0.056 |
| Tri-glycerides | 0.000 | 0.000 | 0.000 |
| Bound glycerol | 0.0146 | 0.0144 | 0.0145 |

TABLE 2.2
Factorial experiment design and experimental results in Stage I.

| | Variables | | | | Results | |
|---|---|---|---|---|---|---|
| | A | B | C | D | Bound glycerol | |
| Expt'l | Catalyst | Methanol | Temperature | Time | (% wt) | |
| No. | (% wt) | (moles) | (° C.) | (minutes) | Average | SD |
| 1 | 0.5 | 0.1 | 100 | 5 | 0.12 | 0.00 |
| 2 | 0.5 | 0.1 | 100 | 15 | 0.11 | 0.00 |
| 3 | 0.5 | 0.1 | 170 | 5 | 0.22 | 0.01 |
| 4 | 0.5 | 0.1 | 170 | 15 | 0.25 | 0.00 |
| 5 | 0.5 | 1 | 100 | 5 | 0.01 | 0.02 |
| 6 | 0.5 | 1 | 100 | 15 | 0.00 | 0.00 |
| 7 | 0.5 | 1 | 170 | 5 | 0.40 | 0.02 |
| 8 | 0.5 | 1 | 170 | 15 | 0.46 | 0.01 |
| 9 | 1.5 | 0.1 | 100 | 5 | 0.12 | 0.00 |
| 10 | 1.5 | 0.1 | 100 | 15 | 0.12 | 0.00 |
| 11 | 1.5 | 0.1 | 170 | 5 | 0.80 | 0.01 |
| 12 | 1.5 | 0.1 | 170 | 15 | 0.99 | 0.06 |
| 13 | 1.5 | 1 | 100 | 5 | 0.08 | 0.00 |
| 14 | 1.5 | 1 | 100 | 15 | 0.06 | 0.01 |
| 15 | 1.5 | 1 | 170 | 5 | 0.40 | 0.17 |
| 16 | 1.5 | 1 | 170 | 15 | 0.52 | 0.06 |

TABLE 2.3
ANOVA analysis of the four process variables on bound glycerol.

| Source | SS | df | MS | F | P | % Contrib. |
|---|---|---|---|---|---|---|
| Catalyst (A) | 0.432 | 1 | 0.432 | 199 | 0.000 | 11.33 |
| Methanol (B) | 0.121 | 1 | 0.121 | 56 | 0.000 | 3.17 |
| Temperature (C) | 2.222 | 1 | 2.222 | 1026 | 0.000 | 58.34 |
| Time (D) | 0.025 | 1 | 0.025 | 11 | 0.002 | 0.65 |
| A × B | 0.241 | 1 | 0.241 | 111 | 0.000 | 6.33 |
| A × C | 0.288 | 1 | 0.288 | 133 | 0.000 | 7.55 |
| A × D | 0.009 | 1 | 0.009 | 4 | 0.048 | 0.24 |
| B × C | 0.005 | 1 | 0.005 | 2 | 0.153 | 0.12 |
| B × D | 0.000 | 1 | 0.000 | 0 | 0.551 | 0.02 |
| C × D | 0.035 | 1 | 0.035 | 16 | 0.000 | 0.90 |
| A × B × C | 0.351 | 1 | 0.351 | 162 | 0.000 | 9.20 |
| A × B × D | 0.002 | 1 | 0.002 | 1 | 0.326 | 0.06 |
| A × C × D | 0.008 | 1 | 0.008 | 4 | 0.063 | 0.21 |
| B × C × D | 0.000 | 1 | 0.000 | 0 | 0.974 | 0.00 |
| Error | 0.072 | 33 | 0.002 | | | 1.87 |
| Total | 3.814 | 47 | | | | |

TABLE 2.4
Stage II experimental design and results.

Variables

| | | | |
|---|---|---|---|
| | A | C | Bound glycerol |
| Expt'l. | Cat. Conc. | Temp. | (% wt) |

| No. | (% wt) | (° C.) | Avg. | SD |
|---|---|---|---|---|
| 1 | 1 | 100 | 0.11 | 0.00 |
| 2 | 1.25 | 100 | 0.12 | 0.00 |
| 3 | 1 | 170 | 0.67 | 0.03 |
| 4 | 1.25 | 170 | 0.83 | 0.02 |
| 5 | 0.5 | 125 | 0.14 | 0.02 |
| 6 | 1.5 | 125 | 0.40 | 0.05 |
| 7 | 0.5 | 150 | 0.19 | 0.01 |
| 8 | 1.5 | 150 | 0.76 | 0.10 |

TABLE 3.1
Fatty acid profile of canola oil.

| | Composition (% wt) | | |
|---|---|---|---|
| Fatty Acids | Test 1 | Test 2 | Average |
| Palmitic (16:0) | 4.4 | 4.5 | 4.5 |
| Stearic (18:0) | 1.8 | 1.8 | 1.8 |
| Oleic (18:1) | 60.9 | 60.5 | 60.7 |
| Linoleic (18:2) | 19.1 | 19.1 | 19.1 |
| Linolenic (18:3) | 9.5 | 9.5 | 9.5 |
| Eicosic (20:1) | 1.8 | 1.8 | 1.8 |
| Erucic (22:1) | 0.8 | 1.0 | 0.9 |

TABLE 3.2
Acid and water content of feedstock.

| | Acid value | Water content |
|---|---|---|
| Sample name | (mg/KOH) | (PPM) |
| Canola oil | 1.3 | 240 |
| Methanol/Catalyst | 0.0 | 800 |

TABLE 3.3
Details of the sieve plate RD column.

| No. | Items | Quantity |
|---|---|---|
| 1 | Number of plates | 20 |
| 2 | Plate spacing (mm) | 53 |
| 3 | Plate thickness (mm) | 1.22 |
| 4 | Number of holes on each plate | 98 |
| 5 | Hole diameter on each plate (mm) | 1.2 |
| 6 | Area of holes on each plate (mm²) | 111 |
| 7 | Triangular pitch (mm) | 4 |
| 8 | Total plate area (mm²) | 1963 |
| 9 | Column inner diameter (mm) | 50 |
| 10 | Weir pipe diameter (mm) | 8.9 |
| 11 | Weir height (mm) | 6.5 |
| 12 | Downcomer area (mm²) | 62 |
| 13 | Net Plate Area (mm²) | 1900 |
| 14 | Active Plate Area (mm²) | 1838 |
| 15 | Liquid hold-up volume (ml)/plate | 11.2 |

TABLE 3.4
Levels of variables and experimental results for both reflux and recycle modes.

| | Variables | | | | Experimental Results | | | |
|---|---|---|---|---|---|---|---|---|
| | A | B | | D | Bound glycerol (% wt) | | | |
| | Catalyst | MeOH:oil | C | Time | Reflux | | Recycle | |
| Expt'l No. | (% wt) | (molar) | Temp. (° C.) | (minutes) | Avg. | SD | Avg. | SD |
| 1 | 0.5 | 9 | 100 | 3 | 1.27 | 0.55 | 0.94 | 0.07 |
| 2 | 0.5 | 9 | 100 | 7 | 0.84 | 0.43 | 0.56 | 0.26 |
| 3 | 0.5 | 9 | 140 | 3 | 1.27 | 0.20 | 1.15 | 0.11 |
| 4 | 0.5 | 9 | 140 | 7 | 0.68 | 0.17 | 0.74 | 0.35 |
| 5 | 0.5 | 15 | 100 | 3 | 0.83 | 0.21 | 0.70 | 0.07 |
| 6 | 0.5 | 15 | 100 | 7 | 0.48 | 0.03 | 0.54 | 0.26 |
| 7 | 0.5 | 15 | 140 | 3 | 0.88 | 0.28 | 0.78 | 0.15 |
| 8 | 0.5 | 15 | 140 | 7 | 0.43 | 0.14 | 0.40 | 0.09 |
| 9 | 1.25 | 9 | 100 | 3 | 0.80 | 0.16 | 0.77 | 0.30 |
| 10 | 1.25 | 9 | 100 | 7 | 0.60 | 0.19 | 0.62 | 0.40 |
| 11 | 1.25 | 9 | 140 | 3 | 0.85 | 0.18 | 0.77 | 0.26 |
| 12 | 1.25 | 9 | 140 | 7 | 0.66 | 0.18 | 0.64 | 0.15 |
| 13 | 1.25 | 15 | 100 | 3 | 0.56 | 0.14 | 0.60 | 0.09 |
| 14 | 1.25 | 15 | 100 | 7 | 0.10 | 0.05 | 0.07 | 0.05 |
| 15 | 1.25 | 15 | 140 | 3 | 0.63 | 0.25 | 0.59 | 0.24 |
| 16 | 1.25 | 15 | 140 | 7 | 0.14 | 0.11 | 0.09 | 0.06 |

TABLE 3.5
ANOVA analysis of the four process variables on bound glycerol.

| Source | SS | df | MS | F | P | Contrib. (%) |
|---|---|---|---|---|---|---|
| Catalyst (A) | 1.0204 | 1 | 1.0204 | 18.180 | 0.000 | 15.60 |
| Methanol:Oil | 1.5632 | 1 | 1.5632 | 27.851 | 0.000 | 23.90 |
| (B) | | | | | | |
| Temperature (C) | 0.0006 | 1 | 0.0006 | 0.010 | 0.921 | 0.01 |
| Time (D) | 1.8665 | 1 | 1.8665 | 33.255 | 0.000 | 28.54 |
| AB | 0.0004 | 1 | 0.0004 | 0.006 | 0.937 | 0.01 |
| AC | 0.0272 | 1 | 0.0272 | 0.485 | 0.491 | 0.42 |
| AD | 0.0398 | 1 | 0.0398 | 0.710 | 0.406 | 0.61 |
| BC | 0.0041 | 1 | 0.0041 | 0.072 | 0.789 | 0.06 |
| BD | 0.0221 | 1 | 0.0221 | 0.393 | 0.535 | 0.34 |
| CD | 0.0138 | 1 | 0.0138 | 0.245 | 0.624 | 0.21 |
| ABC | 0.0049 | 1 | 0.0049 | 0.087 | 0.770 | 0.07 |
| ABD | 0.1137 | 1 | 0.1137 | 2.026 | 0.164 | 1.74 |
| ACD | 0.0112 | 1 | 0.0112 | 0.199 | 0.658 | 0.17 |
| BCD | 0.0001 | 1 | 0.0001 | 0.001 | 0.976 | 0.00 |
| Error | 1.852 | 33 | 0.056 | | | 28.32 |
| Total | 6.540 | 47 | | | | |

TABLE 3.6
Catalyst concentration effect on bound glycerol.

| | | |
|---|---|---|
| Expt'l | Catalyst concentration | Bound glycerol (% wt) |

| No. | (% wt) | Avg. | SD |
|---|---|---|---|
| 17 | 0.7 | 0.34 | 0.10 |
| 18 | 0.9 | 0.28 | 0.08 |
| 19 | 1.1 | 0.19 | 0.07 |

TABLE 3.7
Flow rates of input and output streams for 72-hours test.

| Flow Stream | Flow rate (ml/minute) |
|---|---|
| Canola Oil | 34 |
| Methanol/Catalyst mixture | 4.5 |
| Biodiesel + Glycerol + Catalyst | 38.5 |

TABLE 3.8
Profiles of glycerides, soap and water after reboiler with time.

| | | | | | | Soap in | Water |
|---|---|---|---|---|---|---|---|
| | | MG | DG | TG | | product | escaping |
| Sample | Duration | (% | (% | (% | BG | mixture | reboiler |
| No. | (hours) | wt) | wt) | wt) | (% wt) | (% wt) | (%) |
| 0 | 0 | 0.00 | 0.00 | 0.00 | 0 | 0.0 | 0 |
| 1 | 4 | 0.16 | 0.84 | 0.00 | 0.17 | 0.75 | 85 |
| 2 | 8 | 0.68 | 0.21 | 0.00 | 0.21 | 0.89 | 89 |
| 3 | 12 | 0.64 | 2.10 | 1.90 | 0.50 | 0.81 | 104 |
| 4 | 16 | 0.44 | 1.75 | 3.50 | 0.41 | 0.92 | 149 |
| 5 | 20 | 0.68 | 2.73 | 5.10 | 0.64 | 1.02 | 65 |
| 6 | 24 | 0.76 | 3.08 | 7.50 | 0.73 | 0.94 | 43 |
| 7 | 28 | 0.96 | 3.64 | 3.30 | 0.82 | 0.95 | 50 |
| 8 | 32 | 0.72 | 2.80 | 5.00 | 0.66 | 1.29 | 134 |
| 9 | 36 | 0.88 | 3.71 | 3.40 | 0.82 | 1.21 | 48 |
| 10 | 40 | 0.88 | 2.59 | 5.70 | 0.67 | 1.73 | 68 |
| 11 | 44 | 0.76 | 2.59 | 9.20 | 0.68 | 2.29 | 39 |
| 12 | 48 | 0.80 | 2.87 | 7.50 | 0.71 | 1.85 | 49 |
| 13 | 52 | 0.80 | 4.20 | 7.00 | 0.91 | 1.99 | 72 |
| 14 | 56 | 4.92 | 0.63 | 0.80 | 1.38 | 3.12 | 38 |
| 15 | 60 | 1.60 | 1.75 | 7.30 | 0.75 | 1.93 | 41 |
| 16 | 64 | 1.52 | 2.38 | 8.20 | 0.83 | 1.71 | 43 |
| 17 | 68 | 1.20 | 5.60 | 9.20 | 1.24 | 2.40 | 31 |
| 18 | 72 | 1.24 | 7.42 | 7.20 | 1.50 | 3.0 | 37 |

TABLE 3.9
Profiles of glycerides, soap, and water at various positions after 4 hours.

| | | Residence | | | | | | | |
|---|---|---|---|---|---|---|---|---|---|
| Sampling | Temp. | Time | MG | DG | TG | BG | Soap | Conversion | Water |
| Position | (° C.) | (minutes) | (% wt) | (% wt) | (% wt) | (% wt) | (% wt) | (%) | (PPM) |
| Oil | 55 | 0.0 | 0.0 | 0.0 | 100 | 10.44 | 0.00 | 0.0 | 270 |
| Reservoir | | | | | | | | | |
| Feed | 57 | 0.2 | 1.2 | 3.1 | 76 | 8.71 | 0.05 | 19.7 | 600 |
| mixer | | | | | | | | | |
| Plate 2 | 59 | 0.8 | 1.9 | 6 | 32 | 4.73 | 0.07 | 60.1 | 379 |
| Plate 4 | 60 | 1.4 | 3.1 | 8.2 | 18 | 3.90 | 0.04 | 70.7 | 356 |
| Plate 6 | 60 | 2.0 | 3.8 | 5.6 | 10 | 2.86 | 0.02 | 80.6 | 234 |
| Plate 8 | 60 | 2.5 | 3.4 | 5.5 | 7.0 | 2.43 | 0.05 | 84.1 | 243 |
| Plate 10 | 60 | 3.1 | 2.8 | 4.9 | 3.7 | 1.84 | 0.06 | 88.6 | 309 |
| Plate 12 | 61 | 3.7 | 1.9 | 3.2 | 1.4 | 1.11 | 0.10 | 93.5 | 290 |
| Plate 14 | 61 | 4.3 | 1.5 | 3.1 | 1.1 | 0.96 | 0.08 | 94.3 | 307 |
| Plate 16 | 62 | 4.9 | 0.9 | 2.1 | 0.9 | 0.64 | 0.11 | 96.1 | 540 |
| Plate 18 | 63 | 5.4 | 0.2 | 0.9 | 0.4 | 0.23 | 0.13 | 98.5 | 987 |
| Plate 20 | 64 | 6.0 | 0.6 | 0.2 | 0.2 | 0.21 | 0.20 | 99.6 | 3,000 |
| After | 125 | 6.2 | 0.7 | 0.04 | 0.0 | 0.19 | 0.87 | 99.9 | 250 |
| Reboiler | | | | | | | | | |

TABLE 4.1
Comparison of the Stage 1 (He et al., 2005) with
Stage 2 (current research).

| Parameters | Stage-1 | Stage-2 |
|---|---|---|
| Operation scale | Laboratory/Bench | Bench |
| Time frame (h) | 4-6 | 8 |
| Net methanol molar ratio w.r.t oil | 4.5 | 3.3 |
| Catalyst Concentration (% wt) w.r.t oil | 1.5 | 1.1 |
| Residence time (minutes) | 5.56 | 6.23 |
| Operating Temperatures (° C.) | 100-130 | 120-130 |
| Bound glycerol levels (% wt) | 0.92/1.18 | 0.19 |

I claim:

1. A continuous flow, RD reactor system, that comprises, in combination
a) a reaction column,
b) first means feeding vegetable oil, liquid methanol and catalyst to the upper interior of the column,
c) a condenser reclining methanol vapor for the upper interior of the column, and for producing condensed methanol recycled to the column upper interior, and for delivering a stream of refluxed methanol liquid to the upper interior of the column,
d) and several means for receiving product biodiesel and liquid methanol for the lower interior of the column, and for separating Biodiesel in a primary product stream and returning methanol vapor to the column.

2. The system of claim 1 including receptacle plates within the column to receive said feed oil, methanol and catalyst for mixing and separating methanol vapor from oil and catalyst draining through the plates.

3. The systems of claim 1 wherein said second means includes a re-boiler receiving said biodiesel and methanol liquid for the lower interior of the column and operating to produce methanol vapor returned to the column, and biodiesel in said product stream.

4. The system of claim 1 wherein the temperature within the column interior is between about 60° C. to 65° C.

5. The system of claim 1 wherein the feed oil and methanol are pre-heated to a temperature of about 57° C.-60° C.

6. The system of claim 1 wherein
i) the temperature within the column interior is between about 60° C. to 65° C., and
ii) the feed oil and methanol are pre-heated to a temperature of about 57° C.-60° C.

7. The system of claim 1 wherein the ratio of methanol and oil in the feed is about 3/1 (molar) for pushing transesterification to near completion.

8. The system of claim 3 including a condenser receiving product biodiesel from the re-boiler for cooling the product stream.

9. The apparatus of claim 1 wherein the re-boiler is in direct operative communication with the lower interior of the column.

10. The method of producing a product stream of biodiesel, that includes the steps
a) providing a reactor column,
b) providing and operating first means feeding vegetable oil, liquid methanol and catalyst to the upper interior of the column,
c) providing and operating a condenser receiving methanol vapor for the upper interior of the column, and for producing condensed methanol recycled to the column upper interior, and for delivering a stream of refluxed methanol liquid to the upper interior of the column,
d) and providing and operating received means receiving product biodiesel and liquid methanol for the lower interior of the column, and for separating Biodiesel in a primary product stream and returning methanol vapor to the column.

11. The method of claim 10 including providing receptacle plates within the column operating to receive said feed oil, methanol and catalyst for mixing and separating methanol vapor from oil and catalyst draining through the plates.

12. The method of claim 1 including providing said second means includes a re-boiler receiving said biodiesel and methanol liquid for the lower interior of the column and operating to produce methanol vapor returned to the column, and biodiesel in said product stream.

13. The method of claim 10 wherein the temperature within the column interior is between about 60° C. to 65° C.

14. The method of claim 1 wherein the feed oil and methanol are pre-heated to a temperature of about 57° C.-60° C.

15. The method of claim 1 wherein
i) the temperature within the column interior is between about 60° C. to 65° C., and
ii) the feed oil and methanol are pre-heated to a temperature of about 57° C.-60° C.

16. The method of claim 1 wherein the ratio of methanol and oil in the feed is about 3/1 (molar) for pushing transesterification to near completion.

17. The method of claim 12 including providing and operating a condenser receiving product biodiesel from the re-boiler for cooling the product stream.

18. The method of claim 1 wherein the product stream is characterized in comparison with ASTM standards, by the following results, which are approximate:

| | | ASTM | |
|---|---|---|---|
| Property | Standards | Limits | Results |
| Bound glycerol (% wt) | ASTM | <0.24 | 0.19 |
| | D6584 | | |
| Total glycerol (% wt) | ASTM | <0.24 | 0.19 |
| | D6584 | | |
| Flash point (° C.) | ASTM D93 | >130 | >150 |
| Kinematic viscosity | ASTM D445 | 1.9-6.0 | 4.0 |
| (40° C.) | | | |
| Acid number (% wt) | ASTM D974 | 0.5 max | 0.0 |
